(19) United States
(12) Patent Application Publication
(10) Pub. No.: US 2001/0010262 A1
(43) Pub. Date: Aug. 2, 2001

(54) Heat exchanger

(76) Inventor: Shuji Komoda, Kariya-city (JP)

Correspondence Address: HARNESS, DICKEY & PIERCE, PLC, 5445 CORPORATE DRIVE, SUITE 400, TROY, MI, 48098, US

(21) Appl. No.: 09/799,456

(22) Filed: Mar. 6, 2001

(30) Foreign Application Priority Data
Aug. 4, 2000 (JP) PCT/JP00/05268
Aug. 6, 1999 (JP) 11-223479
Jul. 25, 2000 (JP) 2000-223227

(51) Int. Cl. F28F 13/18; F28F 19/02; F28F 19/00; F28F 3/00; B23P 15/26; B21D 39/06; B21D 53/02; B21D 53/04; B21D 53/06; B21D 53/08

(52) U.S. Cl. 165/167; 165/133; 165/166; 165/916; 165/134.1; 123/196 AB

(57) ABSTRACT

Oil passages 113 through which oil passes are formed with plates 111, 112 composed of aluminum or an aluminum alloy in an oil cooler, according to the present invention, that is a heat exchanger with an extended life. Moreover, fins 123a composed of a material having a corrosion potential more negative than those of the plates 111, 112 are arranged in cooling water passages 123 through which cooling water, for exchanging heat with oil, passes. A sacrificial corrosive layer 301 having a corrosion potential more negative those of the plates 111, 112 and the fins 123a is formed on each of the surfaces on the sides of the cooling water passages 123 of the plates 111, 112. As a result, the sacrificial corrosive layer 301 is preferentially corroded, and not only the plates 111, 112 but also the fins 123a can be protected. Consequently, the pressure-proof strength of the oil cooler can be maintained, and the product life can be improved.

### CROSS-REFERENCE TO RELATED APPLICATIONS

This application is based upon and claims priority of Japanese Patent Application No. 11-223479, filed Aug. 6, 1999 and No. 2000-223227 filed Jul. 25, 2000, the contents being incorporated therein by reference, and a continuation of PCT/JP00/05268.

### TECHNICAL FIELD

The present invention relates to a heat exchanger, and more specifically to the constitution, and joining by brazing, of heat exchanger parts. The heat exchanger of the present invention can be effectively applied to an oil cooler for cooling engine oil and hydraulic oil (ATF) for the automatic transmissions of automobiles (hereinafter merely referred to as oil) and the like.

### BACKGROUND ART

Radiators and condensers have been made of aluminum for use as heat exchangers for air conditioners for automobiles, etc. Such a heat exchanger can be manufactured by alternately laminating a plurality of tube elements (hereinafter abbreviated to tubes) each composed of a brazing sheet that is made of aluminum or aluminum alloy and a plurality of fins and brazing, for example, vacuum brazing, the laminated tube elements and fins.

For such a heat exchanger, a sacrificial corrosive material showing a corrosion potential more negative than that of the tube surface material is used as the fin material in order to improve the corrosion resistance. It is known that the fins are then preferentially corroded in comparison with the tubes to protect corrosion of the tubes.

An oil cooler that exchanges heat between engine oil or the like and engine cooling water generally has a structure in which a plurality of laminated plates are accommodated within a casing. The spaces formed by the plurality of laminated plates become oil passages through which the oil passes. A space formed by the space outside the oil passages and the casing becomes cooling water passages through which the cooling water passes. In addition, inner fins are arranged in the oil passages to improve the heat exchangeability.

When an oil cooler having such a structure is to be made of aluminum, it is desirable also to provide inner fins as an additional strengthening structure in the cooling water passages to provide pressure-proof strength. However, when a heat exchanger has such a constitution in which fins are preferentially corroded as that of the aluminum-made one explained above, the fins arranged in the cooling water passages are first corroded, and a required pressure-proof strength cannot be maintained. As a result, there arises the problem that the product life of the oil cooler itself is shortened.

### DISCLOSURE OF THE INVENTION

The present invention has been achieved in view of the problems mentioned above. An object of the present invention is to suppress shortening of the product life caused by corrosion.

In order to achieve the object, the present invention provides a heat exchanger for carrying out a heat exchange between oil and cooling water, which comprises:

a plurality of first plates and a plurality of second plates that are composed of aluminum or an aluminum alloy, and that are alternately laminated and joined by brazing;

oil passages which are each formed between one surface of one of the first plates and one surface of one of the second plates that is arranged to face the one surface of the first plate, and through which oil passes;

cooling water passages which are each formed between the other surface of the one of the first plates and one surface of one of the second plates that is arranged to face the other surface of the first plate, and through which cooling water passes; and

cooling water side fins brazed to the inner wall surfaces of the cooling water passages, wherein the cooling water side fins are composed of aluminum or an aluminum alloy having a corrosion potential more negative than those of the core layers of the first plates and the second plates, and a sacrificial corrosive layer having a corrosion potential more negative than those of the core layers of the first plates and the second plates and the cooling water side fins is formed on each of the above other surface of the first plate and the surface of the second plate that faces the above other surface of the first plate.

That is, for the heat exchanger (oil cooler) of the present invention, the sacrificial corrosive layers having a corrosion potential more negative than those of the first and the second plates and the fins on the cooling water sides are preferentially corroded. As a result, not only the first and the second plates but also the fins on the cooling water passage sides can be protected from corrosion. Consequently, even when aluminum or an aluminum alloy having a low strength compared with those of conventional materials is used as a material for the heat exchanger (oil cooler), the pressure-proof strength of the heat exchanger (oil cooler) can be maintained. Moreover, a material having a corrosion potential more negative than that of the core layers of the tubes is used as the fin material of the fins on the cooling water passage sides. Therefore, even when corrosion proceeds in the heat exchanger, the fins on the cooling water sides are preferentially corroded in comparison with the first and the second plates forming the cooling water passages and oil passages; as a result, the period for which the first and the second plates can be used without damage can be prolonged, and the product life can thus be extended.

### BRIEF DESCRIPTION OF THE DRAWINGS

FIG. 1 is a sectional view of an oil cooler according to a first embodiment of the present invention.

FIG. 2 is a sectional view showing main parts of the present invention.

FIG. 3 is a sectional view of an oil cooler according to another embodiment of the present invention.

### BEST MODE FOR CARRYING OUT THE INVENTION

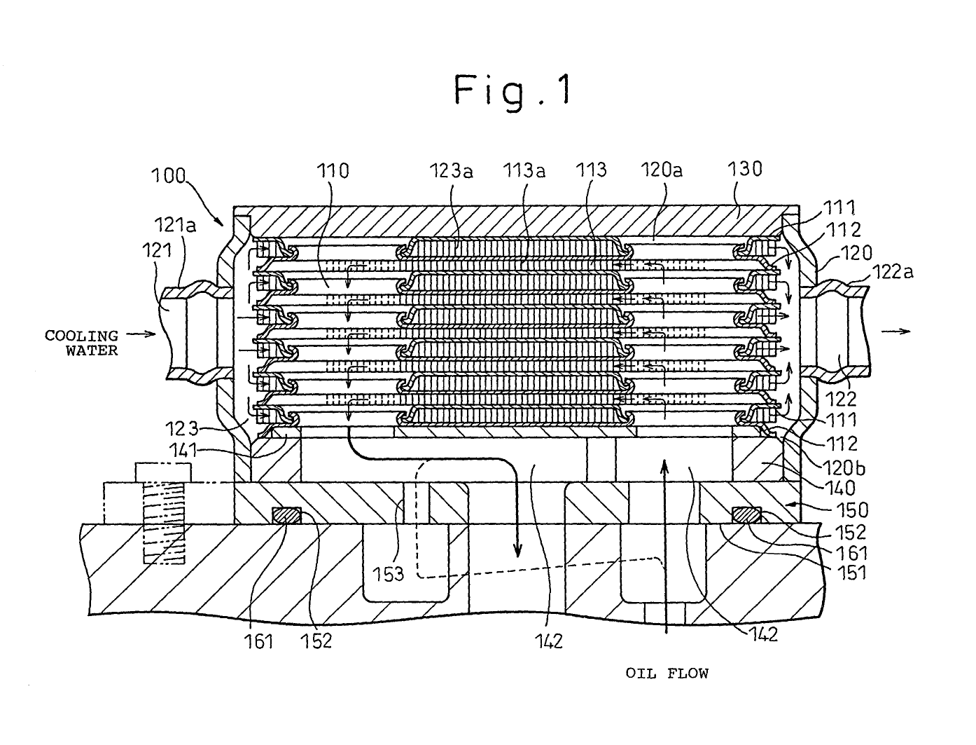

Embodiments according to the present invention will be explained below by making reference to drawings. FIG. 1 is a sectional view of an oil cooler 100 that is one embodiment to which the constitution of the heat exchanger of the present invention is applied.

The oil cooler 100 is mounted on the wall surface of a cylinder block, a crankcase or a transmission main body for a driving engine (not shown). The oil cooler carries out a heat exchange between engine cooling water (hereinafter abbreviated to cooling water) and oil, such as engine oil and hydraulic oil (ATF) for automatic transmission, to cool the oil.

Reference numeral 110 indicates a heat-exchanger core (hereinafter abbreviated to a core) that carries out a heat exchange between the oil and the cooling water. The core 110 is formed by laminating a plurality of plates 111 and a plurality of plates 112 (corresponding to first plates and second plates, respectively) that are press formed in advance to have recesses and protrusions with predetermined shapes for improving the heat exchangeability, in the thickness direction of the plates 111 and the plates 112 themselves. In addition, spaces, which will be explained below, and through which oil passes are formed in the interior between one of the plates 111 and the corresponding plate 112, and the plates 111 and the plates 112 function as tube elements.

Reference numeral 120 indicates an approximately cylindrical casing that accommodates the core 110. A closed space that accommodates the core 110 is formed within the casing 120 by blocking openings 120a, 120b on two respective sides in the axial direction of the casing 120 (top and bottom sides in FIG. 1) with a disk-like top face plate 130 and a disk-like bottom face plate 140, respectively. A cooling water inlet side pipe 121a and a cooling water outlet side pipe 122a are provided to the respective cylindrical wall portions of the casing 120. The cooling water flows in through an inlet 121, and flows out through an outlet 122 after carrying out a heat exchange between the cooling water and the oil in the core 110.

Spaces 113 formed (partitioned) by the plates 111, 112 form passages (fluid passages) through which the oil passes. On the other hand, of spaces formed by the casing 120 and the first and the second plates 130, 140, spaces (spaces within the casing 120) 123 other than the spaces 113 (hereinafter referred to as the oil passages 113) form passages through which the cooling water passes (hereinafter referred to as cooling water passages 123). Spaces formed among the laminated tube elements each formed by a pair of plates 111, 112 become part of the cooling water passages 123 through which the cooling water passes.

In addition, inner fins 113a, 123a having offset shapes that promote a heat exchange between the oil and cooling water are provided within the respective passages 113, 123. Moreover, oil passages 143, through which the oil passes, are formed in the plate 140.

Furthermore, reference numeral 150 indicates a bearing surface plate joined to the second plate 140 by brazing. Of the two side surfaces of the bearing surface plate 150, the side surface opposite to the second plate 140 (the side surface contacted with the wall surface of the cylinder block or crankcase) 151 has an O-ring groove 152 in which an O-ring 161 made of an acrylic rubber is placed. The gap between the surface 151 (hereinafter referred to as the sealing surface 151) and the wall surface of the cylinder block or crankcase is sealed therewith.

In order to ensure a predetermined sealability, the O-ring groove 152 and sealing surface 151 are machine finished to have a predetermined surface roughness (a mean surface roughness for 10 points R_{z} (JIS B0601) of up to 12.5z in the present embodiment).

In addition, reference numeral 153 indicates a bypass hole that makes the oil inlet side communicate with the oil outlet side in the oil cooler 100 while the oil from the inlet side is making a circuit round the core 110 and flows out of the oil outlet side. The by-pass hole 153 has a given hole diameter to prevent the oil from excessively making a circuit round the core 110 and excessively flowing out toward the oil outlet side (excessive pressure loss). Reference numeral 141 indicates an aluminum third plate that is contacted with the lowest plate 112 to reinforce the plate 112.

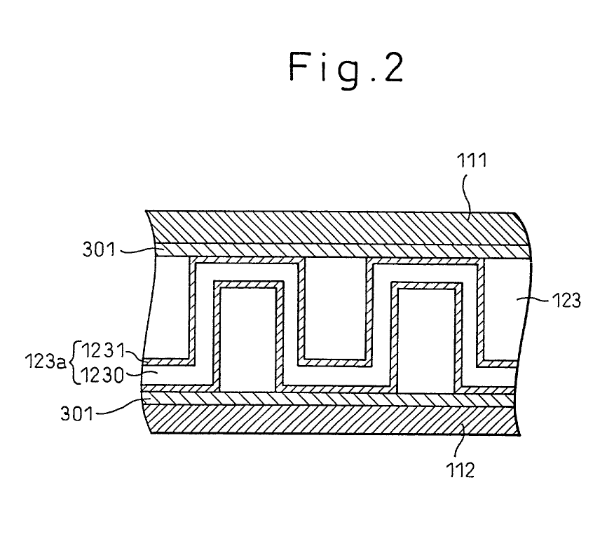

In addition, the plates 111, 112 are formed from aluminum or an aluminum alloy such as an Al-Mn-Cu-based alloy. As shown in FIG. 2, of the surfaces of the plates 111, 112, the surfaces facing the cooling water passages 123 are each clad in a sacrificial material that is formed from an aluminum alloy such as an Al-Zn-based alloy and that has a more negative corrosion potential than the materials of the plates 111, 112 to form a sacrificial corrosive layer 301. On the other hand, a core layer 1230 of the inner fin 123a is formed from aluminum or an aluminum alloy, and the surfaces of the core layer are each clad with a clad layer 1231 composed of a brazing material. In addition, a material such as an Al-Mn-based alloy having a corrosion potential more negative than that of the material of the plates 111, 112 and more positive than that of the sacrificial corrosive layer 301 is used for the core layer 1230 of the inner fin 123a.

For the oil cooler 100 in the present embodiment, the sacrificial corrosive layers 301 with respect to the plates 111, 112 and the inner fin 123a are on the respective surfaces that face the cooling water passage 123 of the plates 111, 112. As a result, the sacrificial corrosive layers 301 are preferentially corroded in comparison with the plates 111, 112 and the inner fin 123a, and the plates 111, 112 and the inner fin 123a are prevented from corrosion. Therefore, the life of the inner fin 123a can be extended and the fin can maintain a required pressure-proof strength. Moreover, the heat exchanger can maintain a predetermined heat exchangeability because the inner fins 123a are protected.

Furthermore, even when the corrosion proceeds further, the inner fins 123a are corroded in preference to the plates 111, 112 because the inner fins 123a are composed of a material having a corrosion potential more negative than those of the plates 111, 112. Accordingly, the period after which the corrosion of the plates 111, 112 takes place can be prolonged, and the product life can be extended.

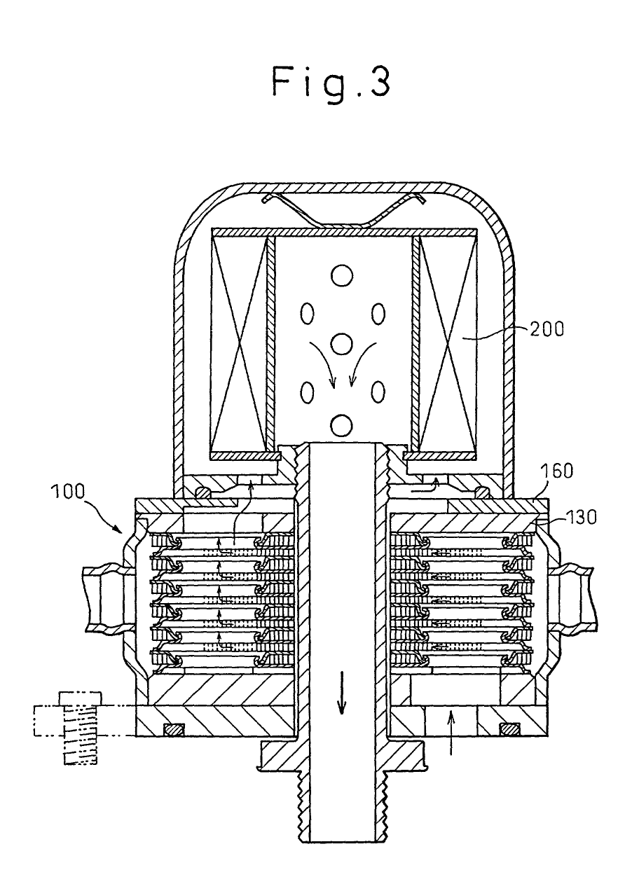

In addition, an explanation of an oil cooler having no filter for cleaning oil has been made in the above embodiment. However, it is needless to say that the present invention can also be applied to an oil cooler integral with a filter in which a filter 200 is integrated into an oil cooler 100 as shown in FIG. 3. In addition, in FIG. 3, reference numeral 160 indicates a bearing surface plate on the filter side.

Moreover, an oil cooler having the core 110 formed by laminating a plurality of the plates 111 and a plurality of the plates 112 has been explained in the above embodiments. However, the core may have another shape. Moreover, there is no specific limitation on the shapes of the plates and fins when the present invention is to be applied.

Furthermore, although the present invention has been applied to oil coolers for automobiles in the above embodiments, it can also be applied to other vehicles such as motorcycles.

Still furthermore, although an explanation has been made of a mode in which the inner fins 123a have a cladding of a brazing material in the above embodiments, the same effects as in the above embodiments can be obtained even when a constitution is adopted wherein bearing parts are used as the inner fins 123a, the plates 111 and the plates 112 forming tubes are clad in a sacrificial material, and the plates are further clad in a brazing material.

Although a cup-like tank T is formed by blocking one end in the axial direction of the casing 120 with the first plate 140 in the above embodiments, a tank may also be integrally formed by a deep drawing (pressing) or a similar procedure.

Industrial Applicability

The product life of the heat exchanger of the present invention can be extended by considering the corrosion potentials of materials forming respective parts in the heat exchanger, and providing sacrificial corrosive layers that are preferentially corroded.

Moreover, a required pressure-proof strength and a desired heat exchangeability of the heat exchanger of the present invention can be maintained by considering the strength of each of the part materials in the heat exchanger.

1. A heat exchanger for carrying out a heat exchange between oil and cooling water, which comprises:
a plurality of first plates and a plurality of second plates that are composed of aluminum or an aluminum alloy, and that are alternately laminated and joined by brazing;
oil passages which are each formed between one surface of one of the first plates and one surface of one of the second plates that is arranged to face the one surface of the first plate, and through which oil passes;
cooling water passages which are each formed between the other surface of the one of the first plates and one surface of one of the second plates that is arranged to face the other surface of the first plate, and through which cooling water passes; and
cooling water side fins brazed to the inner wall surfaces of the cooling water passages, wherein the cooling water side fins are composed of aluminum or an aluminum alloy having a corrosion potential more negative than those of the core layers of the first plates and the second plates, and a sacrificial corrosive layer having a corrosion potential more negative than those of the core layers of the first plates and the second plates and the cooling water side fins is formed on each of the above other surface of the first plate and the surface of the second plate that faces the above other surface of the first plate.

2. A heat exchanger according to claim 1, wherein the heat exchanger is an oil cooler.
